(19) United States
(12) Patent Application Publication
(10) Pub. No.: US 2016/0137209 A1
(43) Pub. Date: May 19, 2016

(54) MOTION-BASED MULTI-SENSOR CALIBRATION

(71) Applicant: GM GLOBAL TECHNOLOGY OPERATIONS LLC, Detroit, MI (US)

(72) Inventors: INNA STAINVAS OLSHANSKY, MODIIN (IL); YOSI BUDA, PETACH-TIKYA (IL)

(21) Appl. No.: 14/546,123

(22) Filed: Nov. 18, 2014

(51) Int. Cl. B60W 40/10; B60W 30/095; G01D 18/00

(52) U.S. Cl. CPC B60W 40/10; G01D 18/008; B60W 30/095; B60W 2420/42; B60W 2420/00

(57) ABSTRACT

A method is provided for motion-based calibration of multiple sensors. A first estimated motion is determined (e.g., for a vehicle or other object) via one of the sensors while determining a second estimated motion via a second of the sensors. A calibration transform is determined and relates the orientation and position of the first sensor to the orientation and position of the second sensor based on the estimated motions received from each sensor.

### TECHNICAL FIELD

The technical field generally relates to automotive vehicles, and more particularly relates to systems and methods for calibrating multiple sensors of the type used in connection with such vehicles.

### BACKGROUND

Recent years have seen a dramatic increase in the use of various types of sensors in automotive vehicles. Such sensors, which may be used for object avoidance, autonomous driving, and the like, may include, for example, video cameras, Lidar, Radar, INS (Inertial Navigation Systems), GPS (Global Positioning Systems), and any other type of sensor capable of sensing some attribute of the vehicle's surroundings.

As with any sensor system, the careful calibration of sensors used in a vehicular context is necessary to provide accurate and precise sensing of objects in the environment. Stated another way, when two sensors are observing the same general scene or object, it is required that both sensors arrive at the same estimate of velocity and position in the common coordinate system. This can be difficult, as sensors generally have different orientations and positions with respect to the vehicle.

Conventionally, calibration is performed extrinsically and offline—that is, a vehicle bearing a number of sensors is placed in a controlled experimental space while the sensors are used to observe or otherwise sense calibration patterns that are moved through the space in a controlled manner. The calibration parameters are then found by seeking transformation that matches calibration pattern interest points. In addition such matching is also usually done semi-automatically and requires a human intervention. Such calibration techniques are costly and time-consuming. Furthermore, sensors may change position and orientation with respect to the vehicle over time, rendering the initial extrinsic calibration inaccurate.

For navigation sensors, providing information about change in sensor position, the calibration procedure based on using the calibration pattern is not applicable and another methodology is required.

Accordingly, it is desirable to provide easier and more robust systems and methods for calibrating multiple sensors in an automotive context. Additional desirable features and characteristics of the present invention will become apparent from the subsequent detailed description and the appended claims, taken in conjunction with the accompanying drawings and the foregoing technical field and background.

### SUMMARY

In accordance with one embodiment, a sensor processing module includes a memory a memory for storing computer-readable software instructions therein, and a processor. The processor is configured to receive a plurality of sensor signals, each associated with an attribute of an environment, and to execute the computer-readable software instructions to determine a first estimated motion via a first sensor signal of the plurality of sensor signals while determining a second estimated motion via a second sensor signal of the plurality of sensor signals; and determine, based on the first estimated motion and the second estimated motion, a calibration transform relating a first orientation and a first position of a first sensor associated with the first sensor signal to a second orientation and a second position of a second sensor associated with the second sensor signal.

In accordance with one embodiment, a method of calibrating a plurality of sensors provided on a vehicle includes determining a first estimated motion of the vehicle via a first sensor of the plurality of sensors while determining a second estimated motion of the vehicle via a second sensor of the plurality of sensors. The first sensor has a first orientation and a first position with respect to the vehicle, and the second sensor has a second orientation and a second position with respect to the vehicle. A calibration transform is determined that relates the first orientation and the first position of the first sensor to the second orientation and the second position of the second sensor based on the first estimated motion and the second estimated motion.

### DESCRIPTION OF THE DRAWINGS

The exemplary embodiments will hereinafter be described in conjunction with the following drawing figures, wherein like numerals denote like elements, and wherein:

FIG. 1 is a conceptual overview of a vehicle in accordance with an exemplary embodiment.

FIG. 2 is a conceptual diagram illustrating a movement of a vehicle including two sensors in accordance with an exemplary embodiment.

FIG. 3 is a conceptual diagram of trajectories of two sensors during movement of a vehicle in accordance with an exemplary embodiment.

FIG. 4 is a flowchart depicting a calibration method in accordance with one embodiment.

### DETAILED DESCRIPTION

The subject matter described herein generally relates to systems and methods for intrinsically calibrating multiple sensors in a vehicle by determining transformation functions relating the sensors to each other while the vehicle is in motion. In that regard, the following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

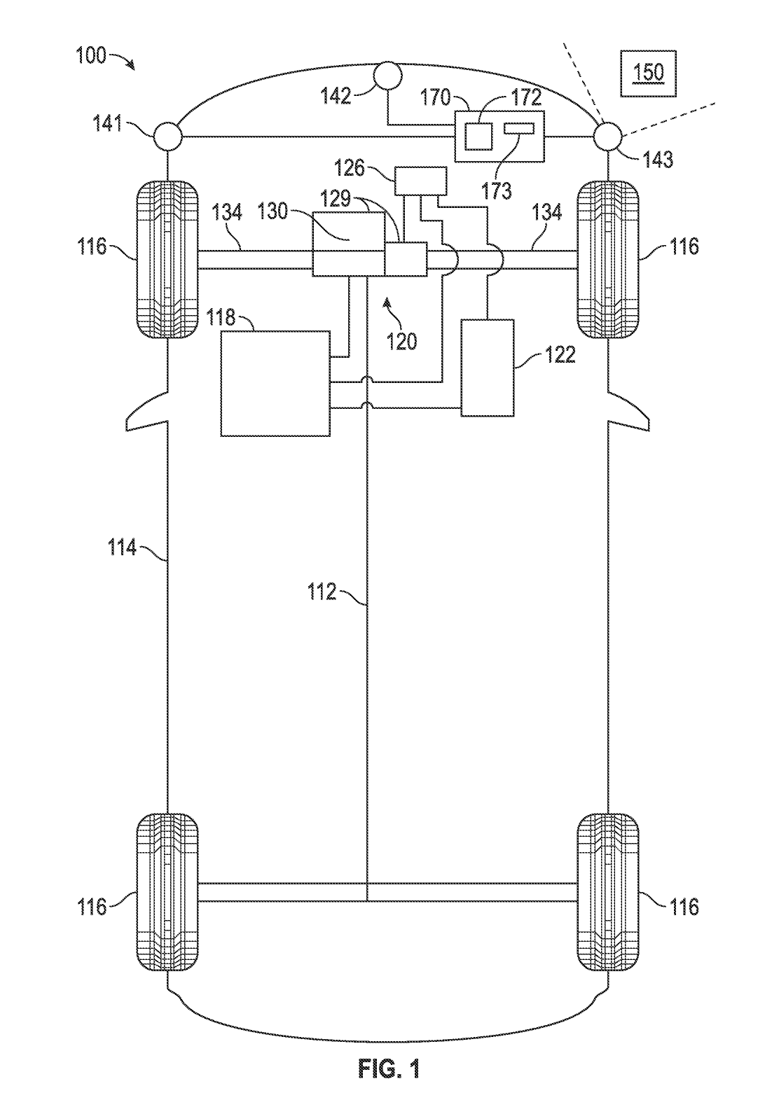

FIG. 1 illustrates a vehicle 100, such as an automobile, according to an exemplary embodiment. The vehicle 100 is also referenced at various points throughout this Application as “the vehicle.” As described in greater detail further below, the vehicle 100 includes a sensor processing module (or simply “module”) 170 communicatively coupled to a plurality of sensors (e.g., 141, 142, 143). Sensors 141-143 are generally configured to sense some attribute of the environment in the vicinity of vehicle 100—e.g., an object or other feature 150—while vehicle 100 is in motion. Using available sensor information received from the sensors 141-143, sensor processing module 170 determines a calibration transform relating the position and orientation of one sensor (e.g., sensor 142) to the position and orientation of another sensor (e.g., sensor 141) based on velocity and motion estimates determined by each of the sensors 141 and 142.

As depicted in FIG. 1, vehicle 100 includes a chassis 112, a body 114, four wheels 116, an electronic control system 118, a propulsion system 130, and the above-referenced sensor processing module 170. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114.

Vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems 130, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and/or an electric motor. The propulsion system 130 is integrated such that it is mechanically coupled to at least some of the wheels 116 through one or more drive shafts 134.

In the illustrated embodiment, vehicle 100 includes a rechargeable energy storage system (RESS) 122 comprising a high voltage vehicle battery, which powers the propulsion system 130, and a drive system comprising an actuator assembly 120, the above-referenced RESS 122, and a power inverter assembly (or inverter) 126. RESS 122 may include a battery having a pack of battery cells, such as a lithium iron phosphate battery and/or a twelve volt (12V) battery that powers auxiliary vehicle functions (e.g. radio and other infotainment, air conditioning, lights, and the like). While the various embodiments are described without loss of generality in the context of an automotive vehicle, the invention is not so limited. Vehicle 100 might by an aircraft, a submarine, a boat, or any other form of transportation that utilizes sensors to determine its motion with respect to the environment.

Sensors 141-143 may be attached to, integrated into, or otherwise securely fixed to vehicle 100, e.g., to body 114 and/or chassis 112. And while only three sensors are illustrated in FIG. 1, it will be understood that any number of sensors may be used in any given vehicle. Furthermore, while sensors 141-143 are illustrated as located near a front portion of vehicle 100, in practice such sensors 141-143 may be located anywhere on, external to, or within vehicle 100 that allows sensors 141-143 to determine the motion of vehicle 100.

Sensors 141-143 may include any type of sensor capable of sensing some attribute of the environment within which vehicle 100 is operating, and are communicatively coupled to sensor processing module 170 in any suitable manner (e.g., via a wired connection, such as an automotive bus, or via one of a variety of conventional wireless connections known in the art). Example sensors include, without limitation, video cameras, Lidar, Radar, INS (Inertial Navigation Systems), GPS (Global Positioning Systems), Ultrasonic etc. Sensors 141-143 may be of the same or different type. For example, sensor 141 may be an INS sensor, while sensor 142 may be a Lidar sensor.

In general, such sensors 141-143 may be roughly categorized as “odometric” (measuring a change in position over time, as with INS and GPS sensors) or “visual” (producing and processing a perceptual image (such as point clouds or occupancy grids) within a field of view). Some sensors may share characteristics of both. In either case, however, the sensors 141-143 are capable of determining an estimate of its speed and orientation (collectively, its velocity) at any given time. In the case of visual sensors, for example, multiple image frames can be analyzed to determine a relative change in three-dimensional position of the sensor relative to the scene and objects being observed. Such motion estimation procedures themselves (such as iterative closest point (ICP) or 3D point-matching with the motion estimation) are known in the art, and need not be described in further detail herein.

Each sensor 141-143 can be characterized by its own orientation and position with respect to vehicle 100. That is, each sensor 141-143 has its own three-dimensional reference frame (x, y, and z axes), as described in further detail. Because of the differing reference frames, each sensor 141-143 will generally sense the environment (and objects in the environment) in a different way, even when sensing the same object. Thus, the purpose of sensor calibration is to ensure that sensors 141-143 have substantially the same “understanding” of the world around them, notwithstanding the differences between their positions and orientations with respect to vehicle 100.

Sensor processing module 170 includes any suitable combination of hardware and/or software capable of performing the various processes described herein. In one embodiment, the sensor processing module 170 includes at least a processor 172 configured to execute software instructions stored within a memory 173. The sensor processing module 170 might also include various types of computer storage, data communication interfaces, and the like. In some embodiments, sensor processing module 170 is part of a larger module—e.g., a vehicle control module.

As mentioned briefly above, sensor processing module 170 is configured to determine, intrinsically (i.e., vehicle 100 is being driven under normal circumstances) a calibration transform relating the orientation and position of one sensor to the orientation and the position another sensor based on estimated motions determined by each sensor during some interval of time. In one embodiment, for example, one sensor (e.g., sensor 141) is considered to be a “reference sensor” or “master sensor,” and calibration transforms are respectively determined for sensors 142 and 143 relative to sensor 141.

As used herein, “calibration transform” means any form of equation, matrix, data structure, or the like that uniquely specifies the difference in positions and orientations between two sensors. For example, the calibration transform might comprise a set of three numbers specifying translation (along x, y, and z axes) and a set of three numbers specifying rotation (around x, y, and z axes). Sensor 142 might then be characterized as being one meter away from sensor 141 along the x-axis (of sensor 141) and rotated 20 degrees about the y-axis (of sensor 141). The calibration transform might take the form of matrix of rigid transform containing a rotation matrix and a shift vector.

In accordance with one embodiment in which two or more of sensors 141-143 have their own clocks, which might be different, the difference in clocks may be estimated based on comparing times at a point in the corresponding trajectory of the vehicle 100. For example, sensor processing module 170 might consider a unique point on the vehicle's trajectory (a corner, a Fourier curve descriptor, etc.) and examine the sensor (and timestamp) data from the two sensors 141 and 142 at that point. The corresponding difference in timestamps then provides an estimate of the difference in clock output. This estimate can be stored along with the calibration transform to assist in characterizing the behavior of the sensors 14 and 142.

The above calibration may be performed by the vehicle 100 at the request of a user, automatically at prescribed times (e.g., every x miles), or in response to the sensor processing module 170 determining that one of the sensors 141-143 has changed by a predetermined threshold (indicating, for example, that the sensor 141-143 has been damaged or moved).

Regardless of how the calibration transform is characterized and stored, its purpose is to uniquely relate the position of one sensor to one or more other sensors. In this way, information provided about the vehicle's surroundings can be processed (e.g., for obstacle avoidance) in real-time knowing that the spatial information is as accurate as possible.

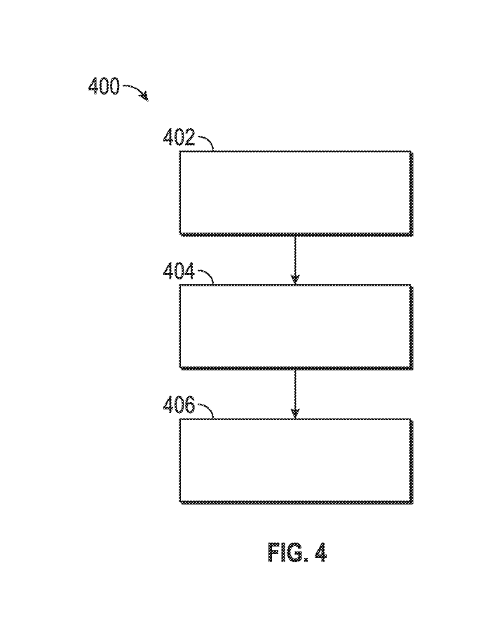

FIG. 4 is a flowchart depicting, in a general sense, a calibration method 400 in accordance with one embodiment and will be described in conjunction with the vehicle 100 and sensors 141-143 as illustrated in FIG. 1.

First, at 402, sensor processing module 170 determines a first estimated motion of vehicle 100 (with respect to its environment) with one of the sensors 141-143 (for the sake of this example, sensor 141), while at the substantially the same time determining a second estimated motion of vehicle 100 via a second sensor (e.g., sensor 141). Sensors 141 and 142 may determine their respective estimated motions in a variety of ways, depending upon the nature of each sensor. For example, if sensor 141 is assumed to be a visual sensor, then its estimated motion can be determined by tracking the motion of a video image as vehicle 100 moves through its environment. Similarly, if sensor 142 is assumed to be an odometric sensor, then its motion can be determined directly from GPS data, INS data, or the like. Determination of estimated motions can be performed exclusively by sensors 141 and 142, or in cooperation with other subsystems within vehicle 100, such as sensor processing module 170, a CAN bus, via vehicle wheel velocities, vehicle yaw rates, integrated accelerometers, or the like.

As noted previously, the first sensor 141 will generally have a first orientation and a first position with respect to vehicle 100, and the second sensor 142 will have a second orientation and a second position with respect to vehicle 100. Accordingly, at 404, sensor processing module 170 determines a calibration transform relating the first orientation and the first position of the first sensor 141 to the second orientation and the second position of the second sensor 142 based on the first estimated motion and the second estimated motion. The manner in which the calibration transform may be determined is described in further detail below.

Finally, at 406, sensor data provided by sensors 141 and 142 during operation of vehicle 100 is processed by sensor processing module 170 utilizing the calibration transform to provide a more accurate determination regarding the position of vehicle 100 with respect to its environment (including, for example, obstacle 150). The resultant determination can used to provide, for example, increased “fusion” of sensor data.

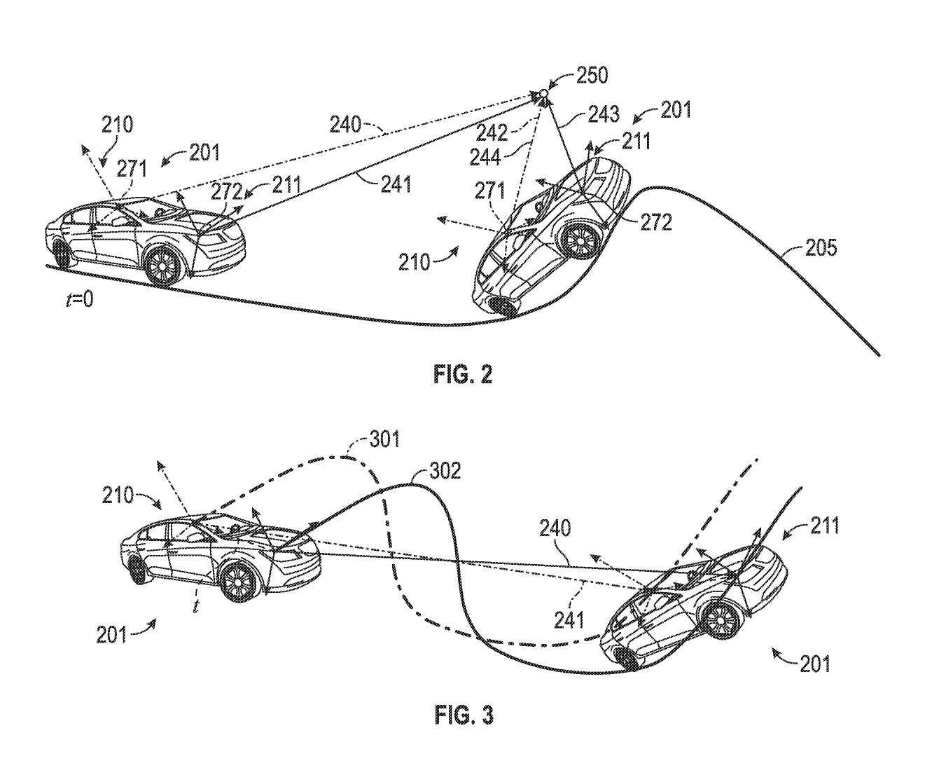

Having thus given a general overview of a calibration method and sensor processing module in accordance with various embodiments, a more detailed and mathematical description regarding of how a calibration transform may be determined will now be provided in conjunction with FIGS. 2 and 3.

In general, FIG. 2 illustrates a vehicle 201 as it moves along a path 205 (from left to right in the figure), with its orientation exaggerated. Vehicle 201 includes two sensors: a sensor 271 having a reference frame (or “dynamic coordinate system”) 210, and a sensor 272 having a reference frame 211. As can be seen, reference frames 210 and 211 vary in position and orientation with respect to vehicle 201. During motion of vehicle 201 along trajectory 205 (from a location 291 to a location 292), reference frame 210 changes in position and orientation. The position and orientation of reference frame 210 at location 291 will be referred to herein as S₀, and the position and orientation at location 292 will be referred herein as S_{τ}, where τ is time, and location 291 corresponds to r=0. Similarly, reference frame 211 changes in position and orientation as vehicle moves from location 291 to location 292 and will be referred to as L₀ and L_{τ}, respectively. Sensors 271 and 272 may correspond to any type of sensor, but in one non-limiting example correspond to an INS sensor and a Lidar sensor, respectively.

In FIG. 2, each sensor 271, 272 observes a common point 250 in the stationary world, and the resulting vectors associated with those observations as vehicle 201 moves along trajectory 205 are designated as p₀ (reference numeral 240), p_{τ} (reference numeral 242), q₀ (reference numeral 241), and q_{τ} (reference numeral 243) for sensors 271 and 272. The augmented values of each p and q ([p;1] and [q:1]) are designated, respectively, as P and Q.

Assuming that sensors 271 and 272 are rigidly coupled to vehicle 201, it will be apparent that, for any time τ:

P_{τ}=TQ_{τ}, (1)

wherein T is a matrix of a rigid transform containing a rotation matrix designated R [3×3], and a shift vector designated t, such that:

$$T = ( \begin{matrix}R & t \\ 0 & 1\end{matrix} ) . \qquad ( 2 )$$

wherein, T (the calibration transform matrix) does not depend on time, as the two sensors 271 and 272 are rigidly connected by vehicle 201. P₀ and P_{τ} (the augmented values of p₀, and p_{τ}, respectively) are thus related as:

P_{τ}=T_{S}^{τ}P₀, (3)

where T_{S}^{τ} is the rigid motion of sensor 271 between the two locations 291 and 292, as determined by sensor measurements from sensor 271.

Similarly,

Q_{τ}=T_{L}^{τ}Q₀, (4)

where T_{L}^{τ} is the rigid motion of sensor 272. Note that T_{L}^{τ} and T_{L}^{τ} have the same structure as calibration transform matrix T. Assuming that T_{L}^{τ} and T_{L}^{τ} are known for any time r, combining equations 1, 3, and 4 gives:

P_{τ}=T_{S}^{τ}P₀=T_{S}^{τ}TQ₀

P_{τ}=TQ_{τ}=TT_{L}^{τ}Q₀ (5), (6)

or, finally,
(7)

As equation 7 is valid for any vector Q₀, this leads to:

T_{S}^{τ}T−TT_{L}^{τ}=0 (8)

The foregoing is based on the observation that if A_{q}=0 for any q and arbitrary matrix A, then A=0. Accordingly, the problem of estimating T is equivalent to solving:

T_{S}^{τ}T=TT_{L}^{τ}, for any τ (9)

Through standard matrix methods, equation 9 can be simplified to:

R_{S}^{k}R=RR_{L}^{k}

R_{S}^{k}t+t_{S}^{k}=Rt_{L}^{k}+t, (10), (11)

Wherein each R denotes a rotation matrix and t denotes a translation matrix. The above can also be expressed as a series of equivalent equations that can be solved iteratively through a numerical solution, i.e.:

R_{S}^{k}t+t_{S}^{k}=Rt_{L}^{k}+t

Rt_{L}^{k}=R_{S}^{k}t−t+t_{S}^{k} or Rxₖ=yₖ,

where xₖ=t_{L}^{k} yₖ=R_{S}^{k}t−t+t_{S}^{k}

(R_{S}^{k}−I)t=Rt_{L}^{k}−t_{S}^{k} or At=b (16), (17)

That is, supposing t exists, one can find R analytically, and likewise, supposing R exists, t can be found analytically. Solving equations 16 and 17 thus involves iteratively solving the equations until convergence to some predetermined level. Knowing R and t, T (the calibration transform matrix) is specified by equation 2, and the spatial relationship between the two sensors has been determined.

FIG. 3 depicts the resulting trajectories 301 and 302 of reference frames 210 and 211, respectively, as vehicle 201 moves from a location 391 to a location 393 as computed based on a calibration transform matrix as determined above.

The trajectory of the sensor origin O_{L} in the initial coordinate system (L₀) is simply q₀^{k}=R_{b}^{k}q_{τ}_{ₖ}+t_{b}^{k}=t_{b}^{k}, where q_{τk}=0 is the origin in its dynamic coordinate system. For the two sensors 271 and 272, their trajectories in their stationary initial coordinate systems (L₀, S₀, respectively) are expressed as q₀^{k}=t_{b,L}^{k} and p₀^{k}=t_{b,S}^{k}. Moreover, for any time τₖ, the trajectories (origins O_{S}, O_{L}) are separated by the vector of the same length t, but with the variable orientation defined by some rotation matrix W^{k} Accordingly, origin O_{S} in the initial coordinate system of L₀ is given by q₀^{k}+W^{k}t. The coordinates of the origin O_{S} in the coordinate system of the second sensor is defined by the same calibration transformation T (Equ. 1), i.e.:

p₀^{k}=R(q₀^{k}+W^{k}t)+t or t^{k}_{b,S}=R(t^{k}_{b,L}+W^{k}t)+t (18)

where p₀^{k} are coordinates of the origin of the coordinate system at time t=τₖ as observed from the static (not moving) sensor coordinate system at initial time t=0. In the dynamic coordinate system rigidly connected with the sensor the origin has coordinate q_{τ}_{ₖ}=0, p_{τ}_{ₖ}=0 this leads to p₀^{k}=t_{b}^{k}, W^{k} is a rotation matrix given by:

W^{k}=−(R_{S}^{k}R)⁻¹=−(RR_{L}^{k})⁻¹. (19)

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A sensor processing module comprising:
a memory for storing computer-readable software instructions therein;
a processor configured to receive a plurality of sensor signals, each associated with an attribute of an environment, and to execute the computer-readable software instructions to:
determine a first estimated motion via a first sensor signal of the plurality of sensor signals while determining a second estimated motion via a second sensor signal of the plurality of sensor signals; and
determine, based on the first estimated motion and the second estimated motion, a calibration transform relating a first orientation and a first position of a first sensor associated with the first sensor signal to a second orientation and a second position of a second sensor associated with the second sensor signal.

2. The sensor processing module of claim 1, wherein the first sensor signal is an odometric sensor signal, and the second sensor signal is a visual sensor signal.

3. The sensor processing module of claim 1, wherein the processor is further configured to estimate a difference between a first clock associated with the first sensor signal and a second clock associated with the second sensor signal.

4. The sensor processing module of claim 1, wherein the calibration transform is stored in the memory as as a rotation matrix and a shift vector.

5. The sensor processing module of claim 4, wherein the processor, executing the software, is configured to determine the calibration transform by iteratively solving a system of equations including the rotation matrix and the shift vector.

6. The sensor processing module of claim 5, wherein the processor, executing the software, is further configured to facilitate obstacle avoidance for a vehicle based on the calibration transform applied to first sensor data from the first sensor and second sensor data from the second sensor.

7. A method of calibrating a plurality of sensors provided on a vehicle, the method comprising:
determining a first estimated motion of the vehicle via a first sensor of the plurality of sensors while determining a second estimated motion of the vehicle via a second sensor of the plurality of sensors, the first sensor having a first orientation and a first position with respect to the vehicle, and the second sensor having a second orientation and a second position with respect to the vehicle; and
determining, via a processor, a calibration transform relating the first orientation and the first position of the first sensor to the second orientation and the second position of the second sensor based on the first estimated motion and the second estimated motion.

8. The method of claim 7, wherein the first sensor is an odometric sensor, and the second sensor is a visual sensor.

9. The method of claim 8, wherein the visual sensor determines the second estimated motion based on observation of a feature of the environment of the vehicle during movement of the vehicle.

10. The method of claim 7, wherein the first sensor includes a first clock, the second sensor includes a second clock, and the method further includes estimating a difference between the first clock and the second clock based on comparing times at a point in a trajectory of the vehicle.

11. The method of claim 7, further including storing, in a memory, the calibration transform as a rotation matrix and a shift vector.

12. The method of claim 11, wherein determining the calibration transform includes iteratively solving a system of equations including the rotation matrix and the shift vector.

13. The method of claim 7, further including providing obstacle avoidance for the vehicle based on the calibration transform applied to first sensor data from the first sensor and second sensor data from the second sensor.

14. A vehicle comprising:
a plurality of sensors, each configured to sense an attribute of an environment of the vehicle:
a sensor processing module communicatively coupled to the plurality of sensors, the sensor processing module configured to:
determine a first estimated motion of the vehicle via a first sensor of the plurality of sensors while determining a second estimated motion of the vehicle via a second sensor of the plurality of sensors, the first sensor having a first orientation and a first position with respect to the vehicle, and the second sensor having a second orientation and a second position with respect to the vehicle; and
determine, via a processor, a calibration transform relating the first orientation and the first position of the first sensor to the second orientation and the second position of the second sensor based on the first estimated motion and the second estimated motion.

15. The vehicle of claim 14, wherein the first sensor is an odometric sensor, and the second sensor is a visual sensor.

16. The vehicle of claim 15, wherein the visual sensor determines the second estimated motion based on observation of a feature of the environment of the vehicle during movement of the vehicle.

17. The vehicle of claim 14, wherein the first sensor includes a first clock, the second sensor includes a second clock, and the sensor processing module is further configured to estimate a difference between the first clock and the second clock based on comparing times at a point in a trajectory of the vehicle.

18. The vehicle of claim 14, wherein the sensor processing module stores, in a memory, the calibration transform as a rotation matrix and a shift vector.

19. The vehicle of claim 18, wherein the sensor processing module determines the calibration transform by iteratively solving a system of equations including the rotation matrix and the shift vector.

20. The vehicle of claim 14, wherein the sensor processing module further facilitates obstacle avoidance for the vehicle based on the calibration transform applied to first sensor data from the first sensor and second sensor data from the second sensor.
